(19) United States
(12) Patent Application Publication
(10) Pub. No.: US 2011/0303614 A1
(43) Pub. Date: Dec. 15, 2011

(54) Method of Flocculation

(76) Inventor: Hisaaki Ochiai, Tokyo (JP)

(21) Appl. No.: 13/201,458

(22) PCT Filed: Sep. 25, 2009
(86) PCT No.: PCT/JP2009/004844

§ 371 Date: Aug. 14, 2011

(30) Foreign Application Priority Data
Mar. 5, 2009 (JP) 2009-051433

(51) Int. Cl. C02F 1/52; B01D 24/00; B01D 21/08; B01D 21/01; B01D 21/02

(52) U.S. Cl. 210/715; 210/738; 210/715

(57) ABSTRACT

A coagulation treatment method for water to be treated that is capable of reducing the degree of inflow of micro flocs reaching a sand filtration layer while realizing a higher density and miniaturization of micro flocs and flocs in a state where the use of an inorganic coagulant is limited by dramatic improvement in residual percentage in a contact-media accumulation tank, based on obtaining a residual percentage (filtration rate) not less than 80% of flocs with particle diameters not less than 7.0 μm in a contact-media accumulation tank from a stage that the water to be treated starts to pass through by interposing the contact-media accumulation tank in a micro flocculation step and a sand filtration step, and filling flocs with particle diameters not less than 7.0 μm in advance at an inlet of the contact-media accumulation tank and/or the vicinity of the inlet.

### TECHNICAL FIELD

The present invention relates to a coagulation treatment method for water to be treated including a micro flocculation step for forming micro flocs by agglomerating fine suspended particles contained in water to be treated by injecting an inorganic coagulant into the water to be treated such as river water, rain water and water discharged from plants, and a step for trapping (filtrating) flocs through a contact-media accumulation tank and a sand filtration layer while accelerating flocculation of the micro flocs.

### BACKGROUND ART

Coagulation treatment for water to be treated is adopted as a prior treatment of sand filtration, and in this coagulation method, an inorganic coagulant is injected into water to be treated to agglomerate micro flocs which are fine suspended particles contained in the water to be treated into flocs as much as possible, and trapping (filtrating) flocs is an essential step.

The search for kinds and amounts of coagulants and coagulant aids necessary for forming flocs having a larger diameter has been a major technical challenge in the coagulation treatment method according to conventional technologies.

An existing coagulation treatment method has been based on the following general equation proposed by Smoluchowski.

dN/dt=αβnᵢ·nⱼ [Equation 1]

wherein N stands for the number of fine suspended particles and micro flocs in unit volume; α, collision efficiency which stands for deposit efficiency when two particles collide, and will vary depending on an inorganic coagulant; β, collision frequency of two particles; nᵢ, the number of particles which will flow per unit volume; and nⱼ, the number of existing particles in unit volume.

In addition, dN/dt expressed by the above general equation indicates a speed of reducing fine suspended particles and micro flocs per unit time, which is referred to as floc forming speed.

In addition, a coagulation theory based on the above described Smoluchowski equation has been explained in such a way that, for example, as disclosed in Non-Patent Document 1, a conventional process is used to divide a step of agglomeration into two steps, more specifically a micro flocculation step for neutralizing the charge of fine suspended particles contained in water to be treated and agglomerating these suspended particles into micro flocs whose diameter is approximately 3.0 μm, is dependent on Brownian motion, and a flocculation step for agglomerating the micro flocs whose diameter is not less than 3.0 μm into flocs which can be settled and separated is dependent on whether or not agitation is conducted by force of agitation greater than a predetermined level.

However, on the other hand, Non-Patent Document 2 has reported that flocs will be destroyed on agitation conducted strongly and rapidly. Further, due to influences of an explanation that the flocs are destroyed by shearing force which deteriorates the floc surface, slow agitation relatively lower in agitation intensity has been adopted in a floc forming step.

In reality, rapid coagulation sedimentation basins have been mostly developed in the U.S.A. However, as described above, agitation by water streams lower in agitation intensity has been adopted in a micro flocculation step due to the influence of Non-Patent Document 2.

On the other hand, as shown in Non-Patent Document 3, the Smoluchowski equation has indicated that an increase in the collision frequency β, that is, an increase in agitation intensity, is effective in agglomeration. An experiment has been conducted by using, for example, a sludge blanket-type rapid coagulation sedimentation basin to increase the agitation intensity rapidly. However, a conclusion was reached in the above experiment that where a strong agitation is kept for a prolonged period of time in a micro flocculation step, that is, where a G_{R} value which is rapid agitation intensity and a T_{R} value which is rapid agitation time are increased, a mother floc is destroyed to increase the turbidity of sedimentation-treated water, which is the same as that reported in conventional experiments. As a result, the above-described rapid agitation system is rarely adopted.

As described above, in response to a request so far made for improving the quality of filtered water, on coagulation which is prior treatment, an operation heavily dependent on an increased injection rate of the inorganic coagulant on the assumption that the agglomeration of suspended particles is accelerated and the destruction of flocs is suppressed has been adopted. In particular, in the operation of a rapid coagulation sedimentation basin where no rapid agitation is conducted, an injection rate of the inorganic coagulant is increased to such an extent that there is no room left for immediate improvements.

However, the above-described operation heavily dependent on the increased injection rate of the inorganic coagulant is able to provide results which are substantially satisfactory in terms of sedimentation but raises other technical problems at the stage of filtration and sludge disposal which are subsequent to the sedimentation.

Specifically, with an increase in the injection rate of the inorganic coagulant, due to an increased volume of the flocs, micro flocs which flow into a filtration basin are made coarse and lower in density and flocculates and agglomerates in sedimentation-treated water are increased in remaining amount in the sedimentation-treated water. As a result, a problem arises that the filtration basin must be washed more frequently.

Further, regarding the sludge disposal, sludge in itself is developed in an increased amount with an increased amount of inorganic coagulant and the sludge is reduced in concentration and dehydration, thus making the sludge disposal difficult.

A fundamental cause behind the problems with the above-described conventional technologies is that despite the fact that coagulation, sedimentation, filtration and sludge disposal are operated as an integrated system, the operation has been adopted for the system by giving substantially no consideration to optimal filtration or sludge disposal but only emphasizing the formation of flocs having a larger diameter for optimizing the sedimentation, more specifically, with concern for an increased turbidity of sedimentation-treated water in association with destruction of flocs, there has been selected an agglomeration process which is extremely ineffective and lower in agitation intensity and no attention has been given to the realization of high-quality filtration which is a subsequent treatment.

With the above situation taken into account, Patent Document 1 has made such a proposal that there are provided rapid agitation tanks made in multiple stages, a lower limit of agitation intensity is set in a first tank, while an upper limit of agitation intensity is set in a second tank and subsequent tanks, and an inorganic coagulant is injected in a divided manner to each of the rapid agitation tanks, thereby improving the efficiency of particle separation and reducing the concentration of the remaining inorganic coagulant (refer to claim 6 and a description related to claim 6).

However, in the above constitution proposed in Patent Document 1, the above effects are obtained insufficiently in that the second and subsequent tanks are limited in agitation intensity more than necessary. Further, an inorganic coagulant is not necessarily adjusted for injection as a whole or criteria for the adjustment are not established. Thus, there is no chance of avoiding such an assessment that the above effects are attained quite insufficiently.

Patent Document 2 has described that a hollow contact-media layer can be arranged to separate micro flocs which are finer in particle diameter and higher in density. However, the contact-media layer has to be washed due to the fact that the layer is clogged more extensively according to retention of the micro flocs, by which the layer is not usable in a sedimentation treatment which is premised on continuous treatment.

Specifically, formation of the micro flocs finer in particle diameter and higher in density may be partially able to reduce the concentration of remaining inorganic coagulant but unable to satisfy a fundamental technical request for continuous treatment. Thus, there is no chance of avoiding such an assessment that the above method is fatally flawed as a coagulation treatment method for water to be treated.

Non-Patent Document 4 has described that in place of a conventional coagulation treatment method lower in agitation intensity and higher in injection rate of the inorganic coagulant, it is preferable to adopt a coagulation treatment method higher in agitation intensity and lower in injection rate of the inorganic coagulant. However, flocs formed by this coagulation treatment method are made finer in particle diameter and higher in density, thereby basic problems are created that micro flocs remain abundantly in sedimentation-treated water. Nevertheless, since a specific constitution for avoiding said basic problems by separating these micro flocs is not indicated at all, there is no chance of avoiding such an assessment that this method is incomplete technically.

In view of the above-described situations, the invention of Japanese Patent Application No. 2008-158743 (hereinafter, abbreviated to “prior invention”) proposes a constitution in which a higher density and miniaturization of remaining micro flocs and flocs are realized upon using an amount used of an inorganic coagulant in a more limited manner than in conventional technologies, and on the other hand, an inclined plate with a small pitch is adopted in a sedimentation basin to prevent the filtration function of the sand filtration layer from being deteriorated by miniaturization of the flocs, whereby efficiently separating micro flocs.

However, as described above, the method for limiting the use of the inorganic coagulant and preventing the filtration function of the sand filtration layer from being deteriorated is not limited to a constitution adopting an inclined plate as in the prior invention.

Specifically, although it is possible to actively utilize a filtration function of a contact-media accumulation tank introduced in Non-Patent Document 5, that is, a coarse particle filtration layer including accumulation of contact media (Raschig ring) that filtrate and trap flocs by contact with micro flocs and flocs, conventional technologies do not disclose or suggest such a constitution capable of reducing the use of an inorganic coagulant by actively utilizing the function of a contact-media accumulation tank at all.

### PRIOR ART DOCUMENTS

### Patent Documents

[Patent Document 1] Japanese Published Unexamined Patent Application No. 2007-203133
[Patent Document 1] Japanese Published Unexamined Patent Application No. H06-304411

### Non-Patent Documents

[Non-Patent Document 1] Norihito Tambo: Basic Research on Coagulation System in Water Treatment (1) to (4), Journal of Japan Water Works Association, No. 361, 363, 365, and 367 (October 1964, December 1964, February 1965, April 1965)
[Non-Patent Document 2] Committee Report: Capacity and Loadings of Suspended Solids Contact Units, J. AWWA, April 1951
[Non-Patent Document 3] Shogo Tsunoda and Katsuyuki Kataoka: Research on Slurry Blanket-Type Rapid Coagulation Sedimentation Plant (2), Effects of Coagulation and Agitation Conditions on Slurry Blanket Layer, Journal of Japan Industrial Water Association, No. 133, pp 39-47, October 1969
[Non-Patent Document 4] Design Guide of Water Works, the Japan Water Works Association, issued in 2000
[Non-Patent Document 5] Norihito Tambo and Mitsuna Kobayashi: Research on High-Capacity Filter Basin (Journal of Japan Water Works Association, No. 571, pp. 37-50, April 1982)

### SUMMARY OF THE INVENTION

### Problem to be Solved by the Invention

An object of the present invention is to provide a constitution of a coagulation treatment method for water to be treated capable of reducing the degree of inflow of micro flocs reaching a sand filtration layer while realizing a higher density and miniaturization of the micro flocs and flocs in a state where the use of an inorganic coagulant is limited as in the prior invention by dramatically improving the residual percentage (filtration rate) inside the contact-media accumulation tank.

### Means for Solving the Problem

In order to achieve the above-described object, a basic constitution of the present invention consists of

(1) a coagulation treatment method for water to be treated, including: an inorganic coagulant injection step for injecting an inorganic coagulant into water to be treated; a micro flocculation step for mixing and agitating the water to be treated into which the inorganic coagulant is injected in a rapid agitation tank to attain in advance micro-flocculation of fine suspended particles in the water to be treated; and a sand filtration step at a final stage, wherein upon interposing a contact-media accumulation tank in which contact media capable of accelerating flocculation of micro flocs and trapping the micro flocs and the flocs are accumulated between the micro flocculation step and the sand filtration step, by filling flocs including flocs with particle diameters not less than 7.0 μm at an inlet of the contact-media accumulation tank and/or the vicinity of the inlet inside the contact-media accumulation tank, a residual percentage (filtration rate) of flocs with particle diameters not less than 7.0 μm in the contact-media accumulation tank at a stage that the water to be treated starts to pass through the contact-media accumulation tank is set to be not less than 80%, and
(2) the coagulation treatment method for water to be treated according to (1) described above, wherein a flocculation step for accelerating flocculation by contact of the micro flocs with existing flocs and a sedimentation separation step for separating the flocs by sedimentation are interposed between the micro flocculation step and the sand filtration step, and the contact-media accumulation tank is provided at a stage before and/or after the flocculation step and the sedimentation separation step.

### Effects of the Invention

In the present invention according to the basic constitution, based on the fact that, at an initial stage that water to be treated passes, by setting the residual percentage (filtration rate) of flocs with particle diameters not less than 7.0 μm to be not less than 80%, not only the flocs with particle diameters not less than 7.0 μm but also flocs and micro flocs with particle diameters not more than 7.0 μm can be trapped (filtrated) in a contact-media accumulation tank at a high rate, in a state where the use of an inorganic coagulant is limited, the function of a sand filtration layer can be further improved by making small the amount of micro flocs reaching the sand filtration layer, and as a result, micro flocs remaining in clarified water are finer and higher in density than in the conventional technologies, so that high-quality clarified water can be obtained, and on the other hand, the amount of sludge produced by use of an inorganic coagulant is reduced, and further, based on this reduction, problems with sludge disposal can be reduced.

### BRIEF DESCRIPTION OF THE DRAWINGS

FIG. 1 show residual percentages (filtration rates) of flocs at a stage that water to be treated has passed through the contact-media accumulation tank, and FIG. 1(a) shows a change situation in a case where flocs including flocs with particle diameters not less than 7.0 μm are not filled at the inlet of the contact-media accumulation tank or the vicinity thereof when the flocculation step and the sedimentation separation step are not interposed, FIG. 1(b) shows a change situation in an embodiment (the case of the arrangement of FIG. 4(a)) in which the filling is performed when the flocculation step and the sedimentation separation step are not interposed, and FIG. 1(c) shows change situations of the number of flocs with particle diameters of 0.5 to 1.0 μm and change situations of turbidity in the cases where the filling is performed and not performed at the inlet of the contact-media accumulation tank or the vicinity thereof in an embodiment (the case of the arrangement of FIG. 4(a)) in which the flocculation step and the sedimentation separation step are not interposed.

FIG. 2 shows a change situation of the residual percentage (filtration rate) of flocs having particle diameter ranges in the contact-media accumulation tank in an embodiment (the case of the arrangement of FIG. 4(b)) in which flocs including flocs with particle diameters not less than 7.0 μm are filled at the inlet or the vicinity thereof between a micro flocculation step, and a flocculation step and a sedimentation separation step.

FIG. 3 is a graph showing a temporal change in turbidity at a stage after passing through a sand filtration layer, and (α) shows a case where neither an inclined plate nor a contact-media accumulation tank is adopted although the flocculation step and the sedimentation separation step are adopted, (β) shows a case of the prior invention adopting an inclined plate after the flocculation step and the sedimentation separation step, and (γ) shows an embodiment (the case of the arrangement of FIG. 4(a)) in the present invention without adopting the flocculation step and the sedimentation separation step.

FIG. 4 show embodiments relating to arrangements of the contact-media accumulation tank of the present invention, and FIG. 4(a) shows an embodiment in which the contact-media accumulation tank is directly interposed between the micro flocculation step using a rapid agitation tank and the sand filtration step without interposing the flocculation step and the sedimentation separation step, FIG. 4(b) shows an embodiment in which the contact-media accumulation tank is interposed between the flocculation step and the sedimentation separation step, and the sand filtration step, FIG. 4(c) shows an embodiment in which the contact-media accumulation tank is interposed between the micro flocculation step, and the flocculation step and the sedimentation separation step, and FIG. 4(d) shows an embodiment in which the contact-media accumulation tank is interposed before and after the flocculation and sedimentation separation step.

FIG. 5 show embodiments in a case where the flocculation step and the sedimentation separation step are adopted as steps subsequent to the micro flocculation step using rapid agitation tanks made in multiple stages, FIG. 5(a) shows an embodiment adopting a sludge blanket system, and FIG. 5(b) shows an embodiment in which a sedimentation separation step using a sedimentation basin is adopted after a flocculation step of a conventional system.

FIG. 6 shows an embodiment based on a sectional view in a case where, at a position of the upper limit of filling of flocs including flocs with particle diameters not less than 7.0 μm inside the contact-media accumulation tank, an excess of the flocs is discharged from a discharge port, and a valve at the discharge port is closed at a stage that water to be treated flows in.

### MODES FOR CARRYING OUT THE INVENTION

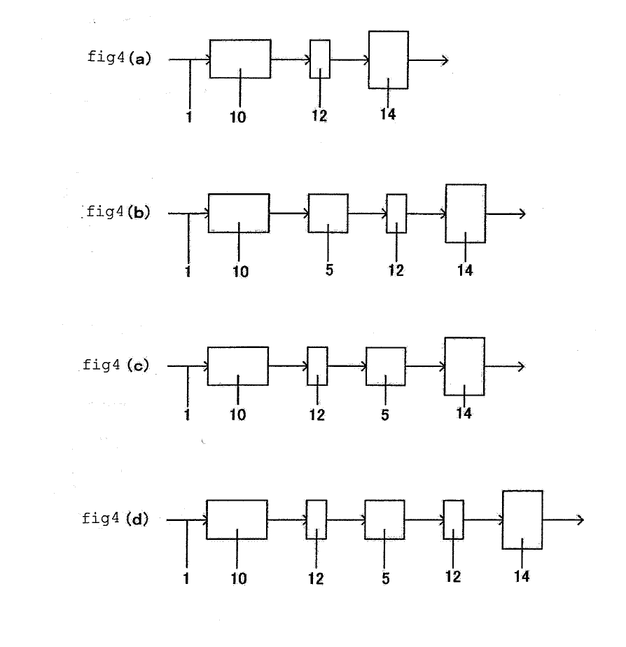

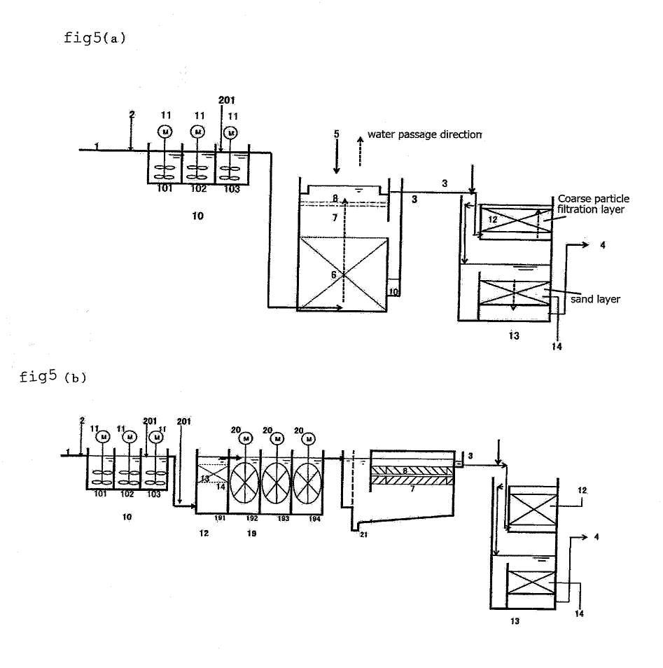

In the basic constitution (1), as shown in FIG. 4(a), FIG. 4(b), FIG. 4(c), and FIG. 4(d), on the assumption that an inorganic coagulant injection step, a micro flocculation step based on mixing and agitation in the rapid agitation tank 10, and a sand filtration step by filtration through the sand filtration layer 14 as a final stage are essential, interposition of the contact-media accumulation tank 12 between the mutual steps is an essential requirement, however, “micro flocs” mentioned in this application means a state of particles at a stage after passing through the rapid agitation tank 10, and “flocs” means a state where the micro flocs are flocculated by mutual collision and their particle diameters increase.

First, the relationship between the amount used of the inorganic coagulant and flocculation will be described according to the Smoluchowski equation described in the section of “Background Art.” This equation may be expressed differently as shown below.

dN/dt=−α(4GΦ/π)·N [Equation 2]

wherein N stands for the number of particles (micro flocs or flocs) per unit volume; α, collision efficiency based on influences of inorganic coagulant; G, speed gradient; and Φ, mean volume of particles (micro flocs or flocs) per unit volume.

A general solution of the above elementary differential equation can be expressed as N=Aexp(−kt) (provided that A stands for the number of particles (micro flocs or flocs) per unit volume at a stage of t=0, and k=α(4GΦ/π).

At a stage that micro flocculation is completed, when, as described in the present invention, a general solution for limiting the use of an inorganic coagulant is given as Nₐ, and as in a conventional technology, a general solution for using an inorganic coagulant in a larger amount than the limited use is given as N′ₐ, α, which is a collision efficiency based on the influence of an inorganic coagulant, and Φ, which is a mean volume of flocs or micro flocs per unit volume, have a relationship of Nₐ>N′ₐ as long as N′ₐ is larger than Nₐ.

According to the present invention, by interposing the contact-media accumulation tank 12 between the micro flocculation step and the sand filtration step, flocculation of micro flocs is accelerated, and the micro flocs and the flocs are trapped in the contact-media accumulation tank 12.

In detail, swirling currents are formed in pipe-shaped contact media, and micro flocs in the swirling currents collide with each other (are filtrated), and are flocculated and settled in the pipe-shaped contact media, and micro flocs and flocs are accordingly trapped.

Thus, as long as the number of particles of micro flocs and flocs is reduced by passing through the contact-media accumulation tank 12, at the stage before reaching the contact-media accumulation tank 12, even if the number of micro flocs or flocs (Nₐ) is larger than that in the case of a conventional technology (N′ₐ), at the stage after passing through the contact-media accumulation tank 12, micro flocs or flocs are trapped (filtrated), and at the stage that the micro flocs or flocs are further filtrated by the sand filtration layer 14, the number of flocs and micro flocs N finally formed can be made substantially equal to, more preferably, smaller than in the case of the conventional technology.

Additionally, when the density of flocs and micro flocs is made higher by limiting the use of an inorganic coagulant, the frequency of sedimentation of micro flocs remaining in clarified water increases, and as a result, clarified water better in quality can be obtained, and as mentioned above, the amount of sludge production can be reduced.

As described above, the contact-media accumulation tank 12 itself has a function to accelerate flocculation of micro flocs and settle micro flocs and flocs in the contact-media accumulation tank 12.

However, in the above-described basic constitution (1), as a case where the contact-media accumulation tank 12 is interposed between the micro flocculation step and the sand filtration step, a case where no other steps are interposed between these steps, or an embodiment in which between these steps, a flocculation step for accelerating flocculation of micro flocs and a sedimentation separation step for separating flocs by sedimentation are interposed, and the contact-media accumulation tank 12 is interposed at a stage before or after or at both stages before and after the flocculation step and the sedimentation separation step, can be adopted.

Specifically, an embodiment in which the contact-media accumulation tank 12 is interposed without adopting the flocculation step and the sedimentation separation step as shown in FIG. 4(a), an embodiment in which the contact-media accumulation tank 12 is interposed at a stage before the flocculation and sedimentation separation step as shown in FIG. 4(b), an embodiment in which the contact-media accumulation tank 12 is interposed at a stage after the flocculation step and the sedimentation separation step before the sand filtration layer 14 as shown in FIG. 4(c), and an embodiment in which the contact-media accumulation tank is interposed at both stages before and after the flocculation and sedimentation separation step in the sedimentation basin 21, can be adopted.

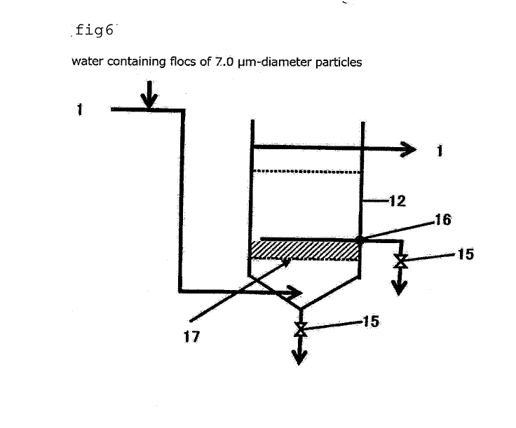

As a system for performing the flocculation step and the sedimentation separation step, a sludge blanket system in which the flocculation and sedimentation separation are performed while raising water to be treated 1 inside a flocculation and sedimentation separation apparatus 5 as shown in FIG. 5(a), and a system in which sedimentation separation is performed by using the sedimentation basin 21 after a conventional system as the flocculation step using agitation by a slow agitator 20, can be adopted as a typical example.

In the prior invention, as a countermeasure against a problem with the sand filtration layer 14, an inclined plate 8 with a small pitch is used in the sedimentation basin 21, and after micro flocs are efficiently separated, excellent sedimentation is secured, however, in the basic constitution (1), by filling flocs including flocs with particle diameters not less than 7.0 μm at the inlet of the contact-media accumulation tank 12 or the vicinity thereof, the residual percentage (filtration rate) of flocs with particle diameters not less than 7.0 μm at the initial stage of passage of the water to be treated 1 through the contact-media accumulation tank 12 is set to be not less than 80%, whereby realizing efficient trapping (filtration) of flocs and micro flocs, and the grounds for this are as follows.

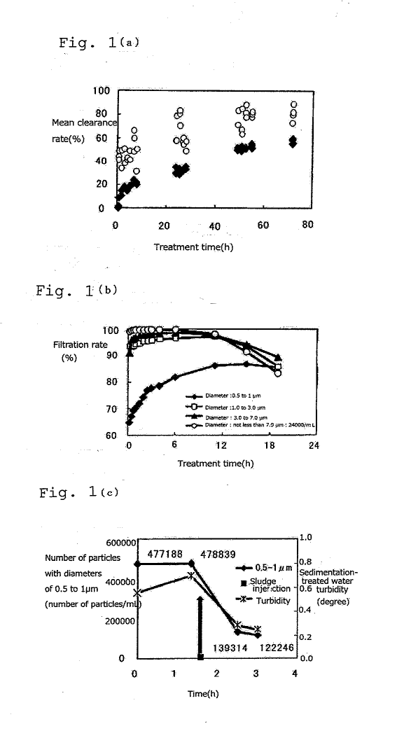

FIG. 1(a) shows temporal changes of the residual percentage (shown with white circles) of flocs with particle diameters not less than 7.0 μm and the residual percentage (shown with black squares) of flocs with particle diameters of 0.5 to 1.0 μm in the contact-media accumulation tank 12 at a plurality of positions of the contact-media accumulation tank 12 when water to be treated 1 is made to pass through the contact-media accumulation tank 12 having a height of 35 cm and a horizontal section of 30 cm² in a state where the contact-media accumulation tank 12 is interposed straight between the micro flocculation step and the sand filtration step as shown in FIG. 4(a) and flocs including flocs with particle diameters not less than 7.0 μm are not filled at the inlet or the vicinity thereof unlike (1) described above (the water-passage speed of the water to be treated 1 passing through the contact-media accumulation tank 12 is 4.0 m/h).

As apparent from the graph of FIG. 1(a), when the mean residual percentage of flocs with particle diameters not less than 7.0 μm reaches 80%, the mean residual percentage of flocs with particle diameters of 0.5 to 1.0 μm also reach approximately 60%.

As apparent from the graph of FIG. 1(a), according to the residual percentage (filtration rate) of flocs with particle diameters not less than 7.0 μm, the residual percentage (filtration rate) of flocs with particle diameters not more than 7.0 μm also tends to be improved.

FIG. 1(b) shows temporal changes of the residual percentage (filtration rate) of flocs in the particle diameter ranges in a contact-media accumulation tank 12 when a contact-media accumulation tank 12 conforming to the same standards as in the case of FIG. 1(a) was used in the same arrangement state as shown in FIG. 4(a) and the flocs passed through the contact-media accumulation tank 12 in a case where 10 liters of an aqueous solution of flocs containing flocs including flocs with particle diameters not less than 7.0 μm in the proportion of approximately 24000/mL was filled at the inlet of the contact-media accumulation tank 12.

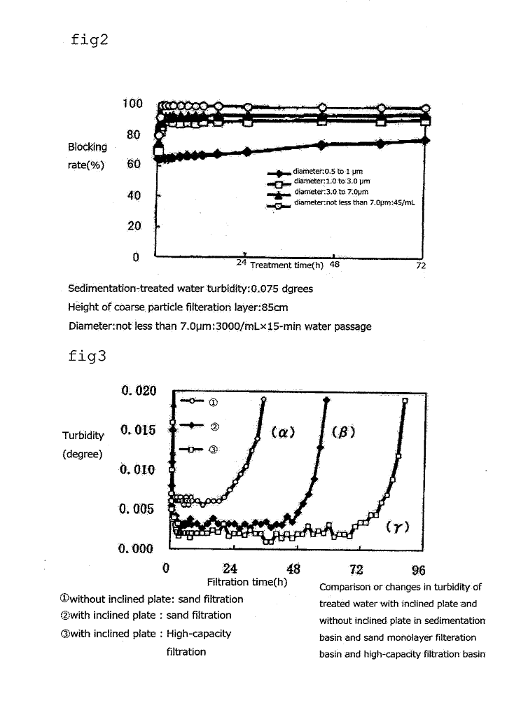

As apparent from FIG. 2(b), the residual percentage (filtration rate) of flocs with particle diameters not less than 7.0 μm is close to 100% at the beginning, and after the elapse of time, the residual percentage (filtration rate) decreases gradually, and reaches approximately 82%.

In contrast, although the residual percentage (filtration rate) of micro flocs or flocs having particle diameters of 0.5 to 1.0 μm which are not greatly coagulated or whose degree of coagulation is small is approximately 64% at the beginning, the residual percentage (filtration rate) gradually increases, and at the final stage, the residual percentage (filtration rate) reaches approximately 85%.

In FIG. 1(b), as in FIG. 4(a), the contact-media accumulation tank 12 is interposed straight between the micro flocculation step and the sand filtration step, and after the micro flocculation step, the flocculation step and the sedimentation separation step using the sedimentation basin 21 are not provided, so that the turbidity at the stage that the water to be treated 1 flows into the contact-media accumulation tank 12 is 20 degrees.

However, at the residual percentage (filtration rate) shown in FIG. 1(b), after the water to be treated 1 passes through the contact-media accumulation tank 12, this turbidity becomes sufficiently low.

As apparent from a comparison between FIG. 1(a) and FIG. 1(b), it is proved as an objective fact that filling of flocs including flocs with particle diameters not less than 7.0 μm at the inlet of the contact-media accumulation tank 12 or the vicinity thereof in advance improves the residual percentage (filtration rate) of flocs.

FIG. 1(c) shows a change situation of the number of flocs with particle diameters of 0.5 to 1.0 μm per unit area and the turbidity at a stage after passing through the contact-media accumulation tank 12 before and after filling approximately 10 liters of aqueous solution of flocs containing flocs with particle diameters not less than 7.0 μm in the proportion of 24000/mL at the inlet of the contact-media accumulation tank 12 at a stage that the water to be treated 1 flows into the contact-media accumulation tank 12 having a height of 40 cm and a horizontal section of 30 cm² at a flow rate of 4 m/h after the micro flocculation step using rapid agitation, and this change objectively proves the operation and effect of the filling.

Specifically, at the stage before the filling, the proportion of flocs with the above-described particle diameters after passing through the contact-media accumulation tank 12 with a height of 40 cm was 480,000/mL, and after the filling, the proportion changes to approximately 140,000 to 122,000/mL, so that approximately 70% or more reduction is realized, and the turbidity also changes from approximately 0.7 to 0.2 degrees, and 70% or more reduction is realized.

As described above, FIG. 1(b) shows an embodiment in a case where, as shown in FIG. 4(a), the contact-media accumulation tank 12 is interposed between the micro flocculation step and the sand filtration step, and the flocculation step and the sedimentation separation step are not interposed, and even in the embodiment shown in FIG. 4(c), that is, the case where the contact-media accumulation tank 12 is interposed at a stage before the flocculation step and the sedimentation separation step after the micro flocculation step, the floc remaining condition corresponding to a state just after micro flocculation is assumed, so that the same temporal changes as in FIG. 1(b) are shown, and the turbidity is also reduced in the same manner.

FIG. 2 shows temporal changes of the residual percentages (filtration rates) of flocs in the particle diameter ranges in a case where, as in FIG. 1(a) and FIG. 1(b), approximately 10 liters of aqueous solution containing micro flocs with particle diameters not less than 7.0 μm in the proportion of 3000/mL is filled at an inlet of a contact-media accumulation tank 12 having a height of 80 cm and a horizontal section of 30 cm² and the turbidity of water to be treated 1 when flowing into the contact-media accumulation tank 12 is 0.1 degrees while the flow rate of the water to be treated 1 is 4 m/h in the embodiment shown in FIG. 4(b), that is, an embodiment in which the contact-media accumulation tank 12 is interposed between the flocculation step and the sedimentation separation step (using the sludge blanket system, in actuality), and the sand filtration step.

As apparent from FIG. 2, the residual percentage (filtration rate) of flocs with particle diameters not less than 7.0 μm in the contact-media accumulation tank 12 is 80% at the beginning; however, it reaches approximately 100%, quickly (in 30 minutes).

It is demonstrated that according to the changes, the residual percentage (filtration rate) of micro flocs and flocs with particle diameters of 0.5 to 1.0 μm exceed 60% from the beginning, and thereafter, it gradually increases and reaches a state where the micro flocs and flocs are sufficiently trapped (filtrated) by the subsequent sand filtration step.

Flocs with particle diameters of 1.0 to 7.0 μm intermediate between the particle diameters of flocs with particle diameters not less than 7.0 μm and flocs with particle diameters of 0.5 to 1.0 μm assume temporal changes intermediate between the case of the particle diameters not less than 7.0 μm and the case of the particle diameters of 0.5 to 1.0 μm.

It is understood that the reason for the lower degree of the increase in residual percentage (filtration rate) of flocs with particle diameters of 0.5 to 1.0 μm shown in FIG. 2 than in the case shown in FIG. 1(b) is that the quantity of flocs with particle diameters not less than 7.0 μm trapped (filtered) in the contact-media accumulation tank 12 becomes smaller than the quantity of micro flocs and flocs with particle diameters not more than 7.0 μm due to passing through the flocculation step and the sedimentation separation step.

Thus, while the embodiment shown in FIG. 4(b) totally shows a residual percentage (filtration rate) more excellent than in the embodiment of FIG. 4(a), a trapping (filtration) effect more excellent than in the embodiment of FIG. 4(b) can be expected in the embodiment of FIG. 4(d) in which the contact-media accumulation tank 12 is interposed at both stages before and after the flocculation step and the sedimentation separation step.

As apparent from a comparison between FIG. 1(b) and FIG. 2, the total residual percentage (filtration rate) becomes lower over time in the case where the contact-media accumulation tank 12 of the basic constitution (1) is interposed just after the micro flocculation step than in the case where the contact-media accumulation tank is interposed after the flocculation step and the sedimentation separation step, and the cause is that, while the contact-media accumulation tank 12 performs a function of flocculation and sedimentation separation of the flocs, trapped flocs and micro flocs gradually become close to a saturated state in the contact-media accumulation tank 12, and the contact-media accumulation tank cannot sufficiently perform the further trapping (filtration) function.

In view of these circumstances, according to an embodiment adopting a plurality of units of contact-media accumulation tanks 12 at a stage just after the micro flocculation step, even if a contact-media accumulation tank 12 closest to the micro flocculation step reaches a saturated state, the following contact-media accumulation tanks 12 can be made to perform an excellent trapping (filtration) function in a non-saturated state.

In the case where a plurality of units of contact-media accumulation tanks 12 are interposed subsequent to the micro flocculation step, it is not required to fill flocs including flocs with particle diameters not less than 7.0 μm at the inlets of all contact-media accumulation tanks 12 and/or the vicinities thereof.

Specifically, in an embodiment in which a contact-media accumulation tank 12 not filled with flocs including flocs with particle diameters not less than 7.0 μm at the inlet and/or the vicinity thereof in advance is provided next to the contact-media accumulation tank 12 at the stage just after the micro flocculation step, the contact-media accumulation tank 12 into which the filling is not performed performs a function to extend the contact-media accumulation tank 12 of the basic constitution (1), and performs a function to reduce the saturation.

Thus, at the stage just after the micro flocculation step in the embodiments of FIG. 4(a) and FIG. 4(c) and the embodiment of FIG. 4(d), an embodiment in which a plurality of units of contact-media accumulation tanks 12 are provided is preferably adopted, and on the other hand, at the stage after the flocculation step and the sedimentation separation step of the embodiment of FIG. 4(c) and the embodiment of FIG. 4(d), there is no risk of the above-described saturated state, so that usually, provision of a plurality of units of contact-media accumulation tanks 12 is not adopted.

However, in the case of the contact-media accumulation tank 12 just before the sand filtration step, by considering a compact space, an embodiment in which a contact-media accumulation tank is provided in a basin positioned above the sand filtration layer 14 and formed by pooling at a stage just before the sand filtration step, is preferably adopted.

As apparent from the description given above, the sand filtration step is started at a stage that the water to be treated 1 passes through the sand filtration layer 14, and the basin is a component of the sand filtration tank 13, but is not a component contributing to the sand filtration step.

As apparent from the description given above, in the basic constitution (1), the reason for setting the residual percentage (filtration rate) of flocs with particle diameters not less than 7.0 μm at a stage after passing through the contact-media accumulation tank 12 to be not less than 80% from the stage that passage of the water to be treated 1 starts on the assumption that flocs including flocs with particle diameters not less than 7.0 μm are filled at the inlet of the contact-media accumulation tank 12 or the vicinity thereof, is only that this setting makes it possible to obtain a sufficient filtration function even for flocs with particle diameters not more than 7.0 μm at a stage before the contact-media accumulation tank 12 regardless of the flocculation step and the sedimentation separation step, and as a result, the filtration function of the subsequent sand filtration layer is supplemented and necessary purification of the water to be treated 1 can be realized.

Thus, in the basic constitution (1), by the contact-media accumulation tank 12, an excellent trapping (filtration) function can be performed not only for flocs with particle diameters not less than 7.0 μm but also for flocs with particle diameters not more than 7.0 μm, so that the injection amount of an inorganic coagulant in the inorganic coagulant injection step can be reduced, and even if the proportion of micro flocs with small particle diameters increases in the micro flocculation step, the excellent trapping (filtration) function can be performed before reaching the sand filtration step.

Additionally, as described in the section of “Effects of the Invention,” micro flocs remaining in clarified water after being treated are finer and higher in density than in the case of a conventional technology, so that while clarified water with low turbidity can be obtained, it is also possible to reduce the amount of sludge production associated with the use of an inorganic coagulant and also dispose of sludge in a less problematic manner due to a reduced amount of the sludge.

In the state of changes in residual percentage (filtration rate) in FIG. 1(b) based on the embodiment of FIG. 4(a), when the turbidity is 20 degrees, water to be treated 1 with this turbidity flows into the contact-media accumulation tank 12, and an increase in turbidity poses a risk of saturating the remaining amount of micro flocs and flocs in the contact-media accumulation tank 12 and reducing the residual percentage (filtration rate).

In view of these circumstances, an embodiment is preferable in which the injection amount of the inorganic coagulant is adjusted so that the turbidity is reduced to degrees or less at a stage before the water to be treated flows into the contact-media accumulation tank.

Reduction in turbidity to 20 degrees or less originally means use of a predetermined amount or less of the inorganic coagulant, however, reduction in turbidity to 20 degrees does not mean use of a large amount of an inorganic coagulant unlike the case of the conventional technology, and micro flocs higher in density are sufficiently realizable by sufficiently guaranteeing (improving) the rapid agitation function of the rapid agitation tank 10.

Further describing the technical significance of the numerical requirement of not less than 80% in the basic constitution (1), the turbidity changes as shown by (a) of FIG. 3 in a case where 9 mg/L of an inorganic coagulant is injected into water to be treated 1 whose turbidity at a stage before flowing into the rapid agitation tank 10 is degrees, and after being subjected to the micro flocculation step involving rapid agitation and the flocculation step and the sedimentation separation step using the sludge blanket system, the water to be treated directly passes through the sand filtration layer 14 without passing through the inclined plate 8 and the contact-media accumulation tank 12, however, as shown in FIG. 5(a), based on the prior invention, the turbidity when water to be treated was made to pass through the sand filtration layer 14 in a case where the flocculation step and the sedimentation separation step using the sludge blanket system were provided, inclined plates 8 with a mounting pitch of 10 mm were provided in two stages as a final stage, and the contact-media accumulation tank 12 was not provided, was as shown by (β) of FIG. 3.

On the other hand, the turbidity changes as shown by (γ) of FIG. 3 in the embodiment of FIG. 4(a) of the basic constitution (1), that is, in a case where, the residual percentage (filtration rate) of flocs was set to 80% by filling approximately 10 liters of a floc-containing water containing flocs with particle diameters not less than 7.0 μm in advance in the proportion of 24,000/mL at the inlet of a contact-media accumulation tank 12 after the contact-media accumulation tank 12 having a height of 40 cm and a horizontal section of 30 cm² is interposed between the micro flocculation step and the sand filtration step without the flocculation step and the sedimentation separation step, and no inclined plate 8 was provided.

The filtration run times (h) and the mean turbidities of (α), (β), and (γ) of FIG. 3 are as shown in the following table.

TABLE 1

| | Filtration | |
|---|---|---|
| | run times | Mean |
| Situation leading to sand filtration | (h) | turbidity |
| (α) of FIG. 3 without inclined plate and | 34 | 0.0080 |
| contact-media accumulation tank | | |
| (β) of FIG. 3 with inclined plate and | 58 | 0.0047 |
| without contact-media accumulation tank | | |
| (γ) of FIG. 3 with contact-media | 88 | 0.0035 |
| accumulation tank with residual percentage | | |
| (filtration rate) not less than 80% of | | |
| flocs not smaller than 7.0 μm without | | |
| inclined plate | | |

The results shown in the table prove that water to be treated 1 can be further purified even in the embodiment shown in FIG. 4(a) than in the prior invention, and confirm the possibility of more excellent purification in the case of the embodiments of FIG. 4(b), FIG. 4(c), and FIG. 4(d).

The contact-media accumulation tank 12 adopted in the basic constitution (1) is normally arranged to have an inlet at the bottom portion and an outlet at the top portion so that water to be treated 1 flows from the lower side to the upper side, and as the height of the contact-media accumulation tank 1 increases, the contribution to the degree of trapping (filtration) of flocs increases.

Specifically, flocs with particle diameters not less than 7.0 μm filled at the inlet or the vicinity thereof are pooled at the floc pooling portion (normally, a pipe-shaped inner portion) inside the contact-media accumulation tank 12 having a predetermined shape (normally, a pipe shape), and in order to perform a trapping (filtration) function to prevent flocs (including both flocs with particle diameters not less than 7.0 μm and flocs with particle diameters not more than 7.0 μm) in the water to be treated 1 that flowed in the contact-media accumulation tank 12 from passing through this pooling portion and flowing and further increase the pooling operation, the height of the contact-media accumulation tank 12 is increased.

Reflecting such a condition, an embodiment in which the height of the contact-media accumulation tank 12 is not less than 35 cm is preferably adopted.

Formation of micro flocs higher in density is also realizable by setting the degree of agitation in the rapid agitation tank 10 to a predetermined level or more.

With attention paid to the action of such rapid agitation, an embodiment is preferably adopted in which the micro flocculation step includes a rapid agitation tank 10 divided into two or more compartments arranged in series so that water to be treated 1 can move sequentially, and

a first coagulant injection step for injecting an inorganic coagulant into a whole or a part of the water to be treated 1 at a stage leading to a first compartment of the micro flocculation step and a second coagulant injection step for injecting an inorganic coagulant into a whole or a part of the water to be treated 1 at a stage leading from a second compartment of the micro flocculation step to a flocculation step are provided, and the injection amounts respectively in the first coagulant injection step and the second coagulant injection step are adjusted.

A description will be given for the principle of the embodiment by referring to a general solution based on the Smoluchowski equation. Where an inorganic coagulant is injected only in an amount of V from the beginning (at a stage of t=0) and the micro flocculation step is not divided into two or more compartments unlike the above-described basic constitution, the number of particles N₁₊₂ per unit time for mean treatment time for micro flocculation given as t=t₁+t₂ can be expressed as N₁₊₂=Aexp(−kt₁−kt₂).

On the other hand, where a micro flocculation step is divided into two or more compartments, as with the previously described basic constitution and a step for injecting an inorganic coagulant is also divided into a first coagulant injection step and a second coagulant injection step, an injection amount of the former is given as V−ΔV, and that of the latter is given as ΔV (ΔV indicates an amount which is smaller at least by one digit than V), further where a mean treatment time for micro flocculation in the first compartment of water to be treated 1 is given as t₁ and a mean treatment time for micro flocculation in the second coagulant injection step is given as t₂ and still further where the number of particles per unit volume at a final stage of the first coagulant injection step is given as N₁′ and the number of particles per unit volume at a final stage of the second coagulant injection step is given as N′₁₊₂, there is provided a relationship of

N₁′=A′exp(−k₁t₁)

(provided that A′ stands for N₁′ at a stage of t=0, that is, the number of micro flocs or k₁=α₁(4GΦ/π), and α₁ stands for a coagulation efficiency corresponding to injection of inorganic coagulant only by V−ΔV per unit volume) and a relationship of

N′₁₊₂=N₁′exp(−k₂t₂)=A′exp(−k₁t₁−k₂t₂)

(provided that A′ stands for N₁′ at a stage of t=0, that is, the number of micro flocs or k₂=α₂(4GΦ/π), α₂ stands for a coagulation efficiency corresponding to injection of inorganic coagulant only by ΔV in the second coagulant injection step, and Φ′ stands for a mean floc volume at a stage that water to be treated 1 flows from the first compartment to the second compartment).

In view of a magnitude relationship between above-described N₁₊₂ and N′₁₊₂, for a predetermined time from an initial time (time to t=t₁), as a matter of course, micro flocs existing in the water to be treated 1 will coagulate under the influence of an inorganic coagulant. It should be noted that all of the thus injected inorganic coagulant is not necessarily involved in micro flocculation but the inorganic coagulant exhibits coagulation action, while being sequentially absorbed into the micro flocs.

In this case, where an amount of the initially injected inorganic coagulant per unit volume is V or V−ΔV (provided that ΔV indicates an amount which is incomparably smaller than V), a difference is hardly found in influence on the coagulation action.

Therefore, a relationship of a α≈α₁ is obtained between α and α₁ which are the respective elements of the above-described k and k₁. Thus, there is also obtained a relationship of k≈k₁.

On the basis of the same grounds, there are obtained relationships of α≈α₂ and A≈A′.

However, as long as a mean volume of micro flocs is reduced due to rapid agitation in the first compartment at a stage leading to the second compartment, there is obtained a relationship of Φ′<Φ.

Since a relationship of a₂<a is obtained, there are at last obtained relationships of a(t₁+t₂)>a₁t₁+a₂t₂ and N′₁₊₂>N₁₊₂. More specifically, where an inorganic coagulant is injected in the same amount per unit volume not to provide and to provide a first compartment and a second and subsequent compartments, coagulation takes place in the latter case to increase in the number of particles to be removed, finally making it possible to conduct coagulation efficiently.

Therefore, as described in the above-described embodiment, where the rapid agitation tank 10 is divided into two or more compartments and an inorganic coagulant is refilled in the second and subsequent compartments, an inorganic coagulant is admixed in a smaller amount as a whole, thus making it possible to secure similar coagulation effects, that is, a similar number of coagulation particles per unit volume.

In the above-described embodiment, as shown in FIG. 5(a) and FIG. 5(b), there is adopted a rapid agitation tank 10 divided into two or more compartments (it is noted that FIG. 5(a) and FIG. 5(b) show a rapid agitation tank 10 divided into three compartments 101, 102, and 103). The rapid agitation tank 10 is adopted, by which particles that will settle in a sedimentation basin 21 and particles that will not settle but will remain in sedimentation-treated water 3 are minimized in mean particle diameter and, therefore, particles to be filtrated at a stage of filtration of the sedimentation-treated water 3 are minimized in particle diameter. As a result, it is possible to miniaturize remaining micro flocs.

Further, in the above-described embodiment, the amount of the inorganic coagulant to be admixed is adjusted (limited) in each of the first coagulant injection step and the second coagulant injection step so that the remaining amount of coagulants and agglomerates is less than a predetermined level. Therefore, while particles bond to each other less frequently via an inorganic coagulant as described in a conventional technology to make micro flocs higher in density, the amount of sludge in itself produced in association with the use of the inorganic coagulant is reduced to improve the concentration and dehydration of the sludge, thus making it easier to dispose of the sludge.

As shown in FIG. 5(a) and FIG. 5(b), a second coagulant injection position 201 may be adopted not only at a stage of the rapid agitation tank 10 subsequent to the second compartment 102 and thereafter but also at a stage after completion of agitation in the rapid agitation tank 10 but prior to a flocculation step.

As an index for indicating a remaining amount of coagulants and agglomerates, an STR (Suction Time Ratio: an index indicated by Ts/Tv where distilled water equal in temperature and volume with water to be treated 1 is used to suck the same filter paper at the same suction level and where the suction time of the water to be treated 1 is given as Ts and that of the distilled water is given as Tv) of water to be treated at a stage that the micro flocculation step is completed greatly influences the residual percentage (filtration rate) of flocs in the contact-media accumulation tank 12 of the basic constitution (1).

In order to obtain an excellent purified state of the water to be treated 1, an embodiment in which STR is 4.0 or less and preferably 2.50 or less and 1.05 or more, is preferably adopted.

The STR is defined in an easily understandable manner as described above. In a strict sense, it is defined by a ratio of STR=Ts/Tv where specimen water, 500 mL, and distilled water equal in temperature and volume are sucked at the respective time of Ts (sec) and Tv (sec) by using a suction device (specifically, a device equipped with a reduced pressure vessel, a filter holder and a suction pump with a vacuum level of 26.7 kPa) to which attached is a membrane filter with a total thickness of 45 mm (a filter made by Advantec Inc. having a mean pore size of 0.45 μm and porosity of 38%).

However, the above-described embodiment is able to adjust (limit) well the amount used of inorganic coagulant which is related to the basic constitution not by using the strictly defined STR but by using the STR as described above.

As described in the above-described embodiment, where an injection amount is adjusted (limited) in the first coagulant injection step and in the second coagulant injection step so as to give the STR of 4.0 or less, it is possible to reduce the amount of fine suspended particles contained in water to be treated 1 and also reduce the destruction of flocs, and as in the basic constitution (1), by raising the residual percentage (filtration rate) of particles with particle diameters not less than 7.0 μm to 80% or more, the residual percentage (filtration rate) of flocs with particle diameters not more than 7.0 μm (including micro flocs) is improved, whereby obtaining filtered water 4 with extremely low turbidity at a stage after the sand filtration layer 14.

In particular, where the inorganic coagulant is adjusted for the injection rate so as to give an STR of 2.5 or less at the beginning of a flocculation step, micro flocs are allowed to grow into large-size micro flocs, for example, those with diameters not less than 30 μm, while reflecting and keeping the property of micro flocs which are finer in particle diameter and higher in density.

Therefore, the large-size micro flocs are smaller in diameter than conventional flocs but made higher in density to have a greater settling speed, thus making it possible to accelerate the sedimentation and separation of the flocs in the sedimentation basin 21 and also the reduction in turbidity of sedimentation-treated water 3.

A reason for setting the above-described STR to be not more than 4.0, more specifically, not more than 2.50 as an upper limit and not less than 1.05 as a lower limit, is based on the fact that STR not more than 1.05 is preferable which makes it possible to guarantee turbidity not more than 20 degrees at a stage that sedimentation in the sedimentation basin 21 is completed.

Hereinafter, description will be given by using examples.

### Example 1

Example 1 is such that water to be treated 1 is made to flow from the lower side to the upper side in the contact-media accumulation tank 12.

As described above, when the water to be treated 1 is moved from the lower side to the upper side, flocs settle as in the case of those inside the sedimentation basin 21 according to collision or contact with the contact media, and coarse filtration efficiency becomes higher than in the case where the water to be treated 1 is moved from the upper side to the lower side.

Such coarse filtration efficiency increases the degree of trapping (filtration) of flocs with particle diameters not less than 7.0 μm inside the contact-media accumulation tank 12, and increases the degree of filtration rate as a whole.

### Example 2

Example 2 is such that the coagulant is re-injected into water to be treated 1 flowing out from the contact-media accumulation tank 12 and flowing into the sand filtration layer 14.

As described above, when 0.5 mg/L or more of the coagulant is re-injected inside the sand filtration layer 14, micro particles inside the sand filtration layer 14 are flocculated, and the filtration efficiency inside the sand filtration layer 14 is improved.

In particular, when water to be treated 1 that passed through the sand filtration layer 14 is used not as clean water but as drain water, flocs with large particle diameters are captured in advance even in the surface layer portion in the sand filtration layer 14, and accordingly, clean water with low turbidity can be obtained, and in this case, re-injection of 0.5 mg/L or more of the coagulant increases the effect of drain water.

### Example 3

Example 3 is such that, as shown in FIG. 6, at a position of the upper limit of filling of flocs including flocs with particle diameters not less than 7.0 μm inside the contact-media accumulation tank 12, an excess of the flocs is discharged from the discharge port 16, and the valve 15 at the discharge port 16 is closed at the stage that water to be treated 1 flows in.

In the case where flocs including flocs with particle diameters not less than 7.0 μm are filled at the inlet of the contact-media accumulation tank 12 or the vicinity thereof, there is a natural proper amount of the flocs to be filled.

Specifically, if the filled amount is excessive, the filtration rate for micro flocs and flocs is rapidly improved, however, in contrast, micro flocs and flocs are rapidly trapped (filtrated) in the contact-media accumulation tank 12, and the time during which the contact-media accumulation tank 12 that enables trapping (filtration) functions inevitably becomes short.

Therefore, in order to properly select an amount of the flocs to be filled and adjust the residual percentage (filtration rate) to be not less than 80%, at a stage before water passage of water to be treated 1, the flocs filled excessively are preferably discharged.

In Example 3, when performing the filling at a stage before water passage of water to be treated 1, the valve 15 is opened to make adjustment so that an excess of the flocs is discharged to the outside through the valve 15 and a pipe and the flocs are not filled at a position higher than the valve 15, and a proper filled amount of the flocs is obtained.

With this adjustment, an excessive filled amount of the flocs can be avoided and the time during which the contact-media accumulation tank 12 can function can be properly set.

FIG. 6 shows a state where the flocs are filled above a mesh 17 at the vicinity of the inlet inside the contact-media accumulation tank 12 (in actuality, filled while coexisting with contact media), however, when the flocs are filled up to the inlet, the mesh 17 is not necessary.

### INDUSTRIAL APPLICABILITY

The present invention is able to find uses in all industrial fields related to disposal of sewage and sludge by using an inorganic coagulant.

### DESCRIPTION OF REFERENCE NUMERALS

1 Water to be treated
2 First injection position of inorganic coagulant (first inorganic coagulant) in first coagulant injection step
3 Sedimentation-treated water
4 Filtered water
5 Flocculation and sedimentation separation apparatus (sludge blanket tank, and agitation tank+sedimentation basin using conventional system)
7 Clarification zone
8 Floc-forming inclined plate
10 Rapid agitation tank
11 Rapid agitator
12 Contact-media accumulation tank
13 Sand filtration tank
14 Sand filtration layer
15 Valve
16 Discharge port
17 Mesh
20 Slow agitator
21 Sedimentation basin
101 First compartment of rapid agitation tank
102 Second compartment of rapid agitation tank
103 Third compartment of rapid agitation tank
191 First compartment of slow agitator
192 Second compartment of slow agitator
193 Third compartment of slow agitator
201 Injection position in second coagulant injection step

What is claimed is:

1. A coagulation treatment method for water to be treated, comprising:
an inorganic coagulant injection step for injecting an inorganic coagulant into water to be treated;
a micro flocculation step for mixing and agitating the water to be treated into which the inorganic coagulant is injected in a rapid agitation tank to attain in advance micro-flocculation of fine suspended particles in the water to be treated; and
a sand filtration step at a final stage,
interposing a contact-media accumulation tank in which contact media capable of accelerating flocculation of micro flocs and trapping the micro flocs and flocs are accumulated between the micro flocculation step and the sand filtration step, and
filling in advance flocs including flocs with particle diameters not less than 7.0 μm at least one of:
an inlet of the contact-media accumulation tank and
a vicinity of the inlet inside the contact-media accumulation tank,
a residual percentage (filtration rate) of flocs with particle diameters not less than 7.0 μm in the contact-media accumulation tank at a stage that the water to be treated starts to pass through the contact-media accumulation tank is set to be not less than 80%.

2. The coagulation treatment method for water to be treated according to claim 1, further comprising the steps of:
a flocculation step for accelerating flocculation by contact of the micro flocs with existing flocs and
a sedimentation separation step for separating the flocs by sedimentation
both interposed between the micro flocculation step and the sand filtration step, and
wherein the contact-media accumulation tank is provided at a stage at least one of before and after the flocculation step and the sedimentation separation step.

3. The coagulation treatment method for water to be treated according to claim 1, further comprising the step of adopting, just after the micro flocculation step, a plurality of units of contact-media accumulation tanks.

4. The coagulation treatment method for water to be treated according to claim 1, further comprising the step of providing, at a stage just after the micro flocculation step, next to the contact-media accumulation tank, a contact-media accumulation tank not filled with flocs including flocs with particle diameters not less than 7.0 μm at least at one of:
the inlet and
the vicinity of the inlet.

5. The coagulation treatment method for water to be treated according to claim 1, further comprising the step of providing, at a stage just before the sand filtration step, a contact-media accumulation tank in a basin positioned above a sand filtration layer and formed by pooling.

6. The coagulation treatment method for water to be treated according to claim 1, wherein as the flocculation step and the sedimentation separation step, one of the following is adopted:
a sludge blanket system, and
a system in which a sedimentation basin is subsequent to an agitation tank.

7. The coagulation treatment method for water to be treated according to claim 1, wherein further comprising the step of causing water to be treated to flow from a lower side to an upper side in the contact-media accumulation tank.

8. The coagulation treatment method for water to be treated according to claim 1, further comprising the step of adjusting, at a stage before the water to be treated flows into the contact-media accumulation tank, an injection amount of the inorganic coagulant so that turbidity becomes not more than 20 degrees.

9. The coagulation treatment method for water to be treated according to claim 1, wherein
in the micro flocculation step, further comprising the step of providing a rapid agitation tank divided into at least two compartments arranged in series so that the water to be treated can move sequentially, and
further comprising:
a first coagulant injection step for injecting an inorganic coagulant into a whole or a part of the water to be treated at a stage leading to a first compartment of the micro flocculation step and
a second coagulant injection step for injecting an inorganic coagulant into a whole or a part of the water to be treated at a stage leading from a second compartment of the micro flocculation step to the flocculation step, and
adjusting injection amounts respectively in the first coagulant injection step and the second coagulant injection step.

10. The coagulation treatment method for water to be treated according to claim 1, further comprising the step of using as an index for indicating a remaining amount of coagulants and agglomerates, an STR (Suction Time Ratio: an index indicated by Ts/Tv where distilled water equal in temperature and volume with water to be treated is used to suck the same filter paper at the same suction level and where the suction time of the water to be treated is given as Ts and that of the distilled water is given as Tv) of water to be treated at a stage that the micro flocculation step is completed is not more than 4.0.

11. The coagulation treatment method for water to be treated according to claim 1, further comprising the step of re-injecting the coagulant into water to be treated flowing out from the contact-media accumulation tank and flowing in the sand filtration layer.

12. The coagulation treatment method for water to be treated according to claim 1, wherein when filling in advance flocs including flocs with particle diameters not less than 7.0 μm at one of the inlet of the contact-media accumulation tank and the vicinity of the inlet inside the contact-media accumulation tank at a stage before water to be treated flows in, further comprising the steps of discharging an excess of the flocs from a discharge port positioned at an upper limit of the vicinity of the inlet, and closing a valve at the discharge port at the stage that the water to be treated flows in.
